(19) United States
(12) Patent Application Publication
(10) Pub. No.: US 2008/0203011 A1
(43) Pub. Date: Aug. 28, 2008

(54) Support Having an Altered Porosity and Membrane for the Tangential Flow Filtration

(76) Inventor: Philippe Lescoche, Faucon (FR)

Correspondence Address: CLARK & BRODY, 1090 VERMONT AVENUE, NW, SUITE 250, WASHINGTON, DC, 20005, US

(21) Appl. No.: 11/587,048

(22) PCT Filed: Apr. 21, 2005
(86) PCT No.: PCT/FR2005/000989

§ 371 Date: Dec. 18, 2007

(30) Foreign Application Priority Data
Apr. 23, 2004 (FR) 0404307

(51) Int. Cl. B01D 63/00; B05D 3/02

(52) U.S. Cl. 210/500.21; 427/376.1

(57) ABSTRACT

A porous support (1) for the tangential filtration of a fluid to be processed, which has at least one surface (3) oriented toward the fluid to be processed flowing in a given direction of flow, and a surface (1₁) for extraction of a fraction called the filtrate, flowing through the porous support, this support being created by modification of an initial support, characterised in that it has a reduced permeability in relation to the initial support, and which is homogeneous when one moves parallel to the surface (3) of the support oriented toward the fluid to be processed in the direction of flow of the fluid to be processed.

This present invention concerns the technical area of tangential separation employing separation elements generally known as membranes. These membranes are generally made from inorganic materials and composed of a porous support and at least one separating layer whose nature and morphology are designed to perform separation of the molecules or of the particles contained in the fluid medium to be processed. Membrane separation separates a liquid containing molecules and/or particles into two parts—a filtrate part containing the molecules or particles that have passed through the membrane, and therefore the support and the separating layer, and a retentate part containing molecules or particles retained by the membrane.

The subject of the invention, more precisely, is the creation of a porous medium, and of a membrane that incorporates such a medium. A membrane is a tangible structure which allows selective blockage or passage under the effect of a driving force for the transfer of substances between the fluid volumes that it separates.

The name of the separation effected depends on the driving force used for the transfer. If the driving force for the transfer is:

an electric field, the separation is called electrodialysis,

a pressure, the separation is called microfiltration, ultrafiltration, nanofiltration or reverse osmosis,

a difference of chemical potential, the separation is called dialysis.

The subject of the invention has a particularly advantageous application in the area of nanofiltration, ultrafiltration, microfiltration, filtration or reverse osmosis.

The separation membrane has two main applications:

extraction in the case where the molecules or particles that are to be recovered pass through the membrane,

concentration in the case where the molecules or particles that are to be recovered are retained by the membrane.

Conventionally, a membrane is defined by the association of a porous support in an inorganic material, such as a ceramic, and of one or more separating layers in an inorganic material. The support has one surface oriented toward the fluid to be processed and therefore for entry of the filtrate, and one surface for the extraction of the filtrate. The separating layer or layers are placed on the surface oriented toward the fluid to be processed and connected together and to the support by a sintering process. These types of membrane are known as composite membranes. These membranes are able to adopt different geometries, in particular of the flat or tubular type. The role of the layers is to perform separation of the molecular or particulate species, while the role of the support is to allow the creation of very thin layers by virtue of its mechanical strength.

Considering that a membrane is characterised by pores extending right through its thickness, across the direction of flow, these pores generally have an asymmetrical morphology (of the “Eiffel Tower” type), with the narrowest part being in contact with the fluid to be processed. This morphology allows one to have a minimum pore diameter in the active part of the pore, resulting in a maximum permeability. This morphology is obtained, in the case of the ceramic membranes, by the stacking of porous media of decreasing grain size onto the porous support.

When the acting force is a pressure, the separation is physical only. The molecules or particles are not altered and are kept in their initial state. The molecules or particles blocked by the membrane are deposited on the surface of the membrane and cause clogging which can be very severe.

In order to reduce the latter, two technologies exist:

tangential unclogging in which the liquid to be processed flows tangentially to the surface of the membrane. This flow causes friction which increases the transfer coefficient,

retrofiltration which consists of returning a part of the filtered liquid in the reverse direction through the membrane.

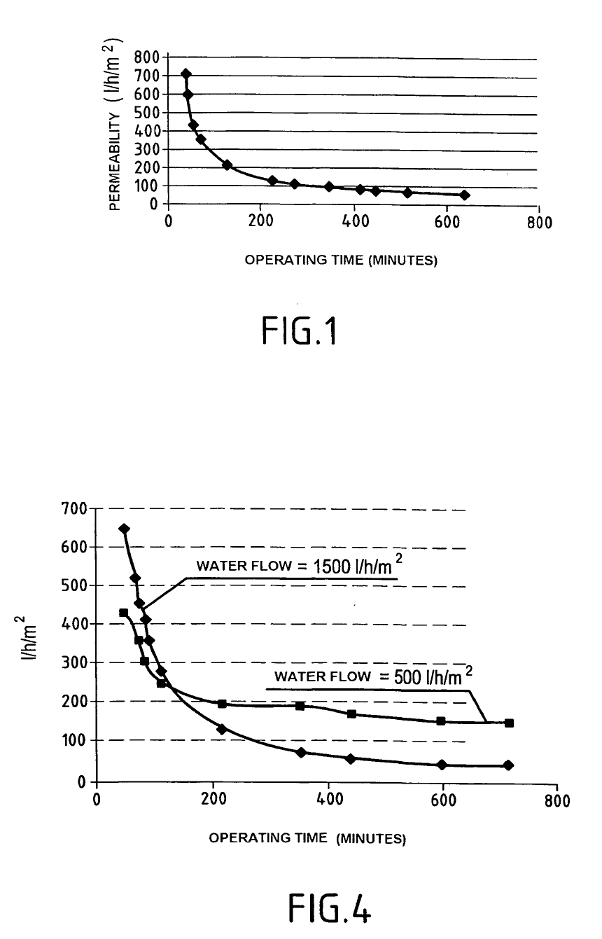

Nowadays, industrial membrane-type installations use tangential unclogging alone or combined with retrofiltration. However, whatever unclogging technique employed, the graphs of permeability as a function of the time always have the appearance of the graph shown in FIG. 1. A sudden drop of permeability is observed in the first few moments of operation of the membrane. This drop stabilises and ends by virtually leveling off. The ratio between the value of the permeability after 720 minutes of operation and that after 4 minutes, is 20. The size of this drop shows that the current unclogging systems are not satisfactory, even though they result in permeability values that are good enough to be economically acceptable.

The explanation for this drop of permeability over time is in the nature of the clogging. In fact, two types of clogging appear, namely surface clogging and clogging in depth. Surface clogging is limited by the tangential flow of the fluid to be processed, since the latter leads to rubbing of the fluid to be processed on the flow surface, thus eliminating any deposit lying on the surface. In principle, retrofiltration should be capable of moving particles physically fixed to the interior of the membrane and thus of limiting any clogging in depth. Nevertheless, the particular morphology of the elements making up the membrane, forming an interconnected network of pores, reduces this possibility.

Neither of these two unclogging methods therefore entirely satisfies. The first few moments of the operation of the membrane are the reason for this limited effectiveness. In fact, in the above example, the permeability of the membrane decreases from the value of permeability to water to the value of permeability to the product. The ratio between these two values is about 20. The particles or molecules arrive at the surface of the membrane at a speed which is equal to the ratio of the flow by the filtering surface. In the first few moments of operation, this speed is maximum, and the degree of movement of a particle or molecule is also maximum. When the impact with the wall occurs, the particle or molecule will penetrate into the interior of the membrane to a depth that is proportional to its degree of movement. Now a particle or molecule that penetrates into the membrane is inaccessible to tangential unclogging. The deeper it penetrates, the harder it is to remove.

It is therefore necessary to avoid this penetration of the particles or molecules into the membrane.

In this context, this present invention proposes a solution that enables this penetration to be avoided, and the permeability of the support and that of the membrane, to be limited when the latter is associated with a separation layer to form a membrane. This present invention therefore has as it subject a porous support for the tangential filtration of a fluid to be processed, which has at least one surface oriented toward the fluid to be processed flowing in a given direction of flow, and an output surface for a fraction called the filtrate, flowing through the porous support. This support is obtained by modification and, in particular by partial clogging, of an initial support, and has a reduced permeability in relation to the initial support, and which is homogeneous when one moves parallel to the surface of the support oriented toward the fluid to be processed, in the direction of flow of the fluid to be processed. Its permeability is preferably reduced by a factor of between 1.5 and 10 in relation to the initial support.

According to another aspect of the invention, over a given constant depth measured from the surface of the support oriented toward the fluid to be processed, the support has an increasing average transverse porosity when one moves toward the interior of the support across the surface of the support oriented toward the fluid to be processed, from the surface oriented toward the fluid to be processed toward the surface the extraction of the filtrate, with, for its part, the average longitudinal porosity of the support being homogeneous when one moves toward the interior of the support, parallel to the surface of the support oriented toward the fluid to be processed, in the direction of flow of the fluid to be processed.

The invention also has as its subject a membrane for the tangential filtration of a fluid to be processed, associating a porous support, like that described above, with at least one separation layer for the fluid to be processed, covering the surface of the support oriented toward the fluid to be processed, with the said separation layer having a porosity that is less than or equal to that of the support.

According to another of its aspects, the invention concerns a process for the manufacture of a porous support, for the tangential filtration of a fluid to be processed, which has at least one surface oriented toward the fluid to be processed, flowing in a given direction of flow, and an output surface for a fraction, called the filtrate, flowing through the porous support, which includes a stage that consists of modifying a porous initial support by penetration, to a more-or-less constant depth, from the surface of the support oriented toward the fluid to be processed, of inorganic particles whose average diameter is less than the average diameter dp of the pores of the initial support, across the surface of the support oriented toward the fluid to be processed, from the surface oriented toward the fluid to be processed toward the surface for extraction of the filtrate, with the average longitudinal porosity of the support, for its part, being homogeneous when one moves toward the interior of the support, parallel to the surface of the support oriented toward the fluid to be processed in the direction of flow of the fluid to be processed.

Various other characteristics will emerge from the description that follows with reference to the appended figures.

FIG. 1 shows the evolution with time of the permeability of a membrane of previous design.

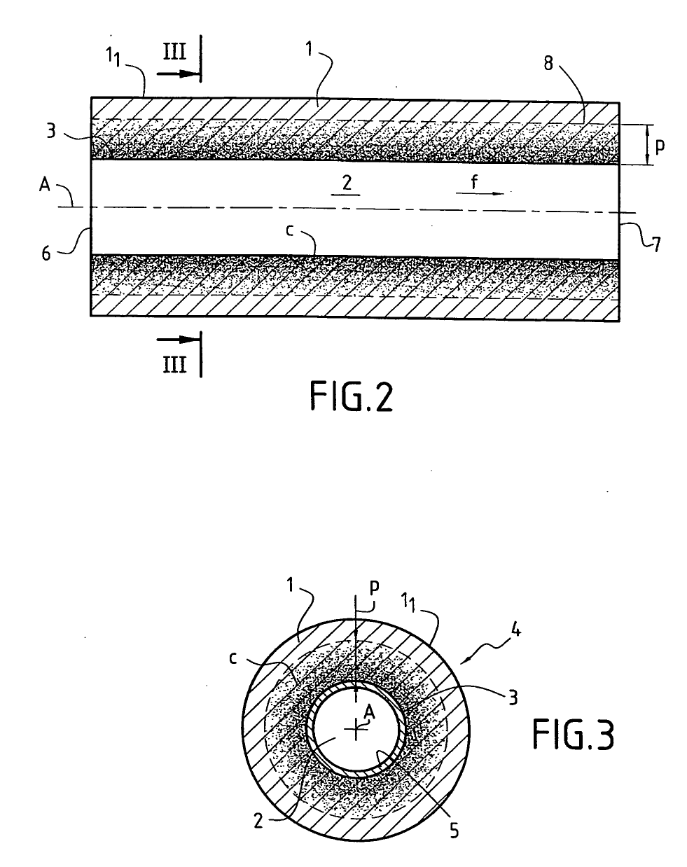

FIG. 2 shows a longitudinal section of a support according to the invention.

FIG. 3 shows a cross section of a membrane according to the invention, that includes a support according to FIG. 2.

FIG. 4 compares the evolution with time of the permeability of a membrane according to the invention with that of a membrane of previous design.

The porous support according to the invention is composed of an inorganic material whose resistance to transfer is adapted for the separation to be effected. The porous support 1 is created from inorganic materials, such as metal oxides, charcoal or metals. In the implementation example illustrated in FIG. 2, the porous support 1 is of extended tubular shape lying along a longitudinal central axis A. A flat shape lying along a central plane could also be adopted. The porous support 1 has a polygonal straight cross section, or as in the example illustrated in FIG. 2, a circular cross section.

The porous support 1 has at least one surface 3 oriented toward the fluid to be processed, which corresponds to the surface over which the fluid to be processed flows when the support is used alone. For the creation of a membrane 4, the support 1 is generally associated with a separation layer 5, in which case the fluid to be processed does not flow directly over the surface 3 of the support oriented toward the fluid to be processed, but rather over the separation layer 5. The surface 3 of the support oriented toward the fluid to be processed is then covered by this separation layer 5, intended to be in contact with the fluid medium to be processed flowing in a given direction and a direction of flow between an upstream end and a downstream end of the support, for such a membrane operating in tangential mode. The nature of the separating layer or layers 5 is chosen as a function of the power of separation or of filtration to be obtained, and with the porous support 1, forms an intimate contact. This layer (or layers) can be placed, for example, from suspensions containing at least one metal oxide and conventionally used in the production of the mineral filtration elements. After drying, this layer (or layers) is subjected to a sintering operation which is used to consolidate them and to bind them together and to the porous support 1. One part of the fluid medium passes through the separating layer 5 and the porous support 1, and the support 1 has an exit surface 1₁ for the extraction of this processed part of the fluid, called the filtrate.

The porous support 1 can be arranged to have at least one and, in the example illustrated in FIG. 2, a channel 2 created parallel to the axis A of the support. In the illustrated example, the channel has a straight cross section at the axis A of the support, of cylindrical shape. The channel 2 has an internal surface 3 which corresponds to the surface 3 of the support oriented toward the fluid to be processed. For the creation of a membrane 4, the support 1 is associated with a separation layer 5. FIG. 3 illustrates an example of the creation of a membrane of the tubular type. According to this example, the channel 2 is covered by a separation layer 5, intended to be in contact with the fluid medium to be processed, flowing within the channel 2, in a given direction of flow between its two open ends. One of these ends is known as the upstream end 6 and the other as the downstream end 7. The fluid to be processed enters into the channel via the upstream end 6 and the retentate exits from the channel via the downstream end 7. The surface 1₁ for extraction of the filtrate corresponds, in the case of membranes that have one or more channels, to the peripheral external surface 1₁ of the support, which is cylindrical and of circular section in the example illustrated in FIGS. 2 and 3.

Prior to the more detailed description of the invention, is it necessary to establish a certain number of definitions. The porosity of the support designates the volume of the pores of the support in relation to the total apparent volume of the support. The porosity is measured by mercury porometry for example. This involves an instrument which sends mercury under pressure into a porous sample. This instrument gives not only the distribution of the pore diameters but also the porosity of the porous bodies.

The average porosity is measured on a volumic slice of a given constant thickness lying in a central direction along which it is desired to measure its variation, if any. To say that this average porosity is homogeneous or more-or-less constant means that when this slice of constant thickness is divided into a series of equal elementary volumes corresponding to sections lying transversally in relation to the central axis of the slice corresponding to the direction of measurement, the average porosity of these elementary volumes does not vary when one moves along the central axis of this slice. To say that this average porosity increases means that the average porosity of the elementary volumes increases.

We will define:

the average longitudinal porosity of the support as the porosity measured when one moves within the support, parallel to the surface oriented toward the fluid to be processed (which corresponds to the internal area of the channel or channels in the case of a single or multi-channel support), in the direction of flow of the fluid to be processed.

the transverse porosity as the porosity measured when one moves transversally within the support, that is perpendicularly, to the surface oriented toward the fluid to be processed.

The flow density per unit of pressure and the permeability of a porous support reflect the ease with which a fluid medium passes through the said support. The flow density, in the sense of the invention, designates the quantity in m³ of filtrate flowing through the unit of area (in m²) of the support per unit of time (in s). The flow density per unit of pressure is therefore measured in m³/m²/s/Pa×10⁻¹².

The permeability, in the sense of the invention, corresponds to the flow density per unit of pressure normalised to the thickness, and is expressed in m³/m²/s/m/Pa×10⁻¹². The permeability is the inverse of resistance. The resistance of a membrane is equal to the sum of the resistances of the support and of the separation layer. Of course in a membrane, the resistance of the support is lower than that of the separation layer since its average pore diameter is higher. The resistance to the transfer of a fluid through a porous body is dependent upon the pore diameter, the porosity, and the thickness of this porous body. To say that a support or a membrane has a homogeneous permeability when one moves parallel to the surface oriented toward the fluid to be processed (which corresponds to the internal area of the channel or channels in the case of a single or multi-channel support), in the direction of flow of the fluid to be processed, means that if this membrane or support is cut into slices lying perpendicularly to the longitudinal axis of the support, in the case of a tubular support, or perpendicularly to the central plane of the support, in the case of a plane support, of equal thickness (taken parallel to the longitudinal axis or to the central plane), the permeability measured for each of these slices is more-or-less constant.

According to the invention, the support 1 has a modified porosity over a depth adjacent to the surface 3 of the support in relation to the remainder of the support. In the vicinity of the surface 3 oriented toward the fluid to be processed, the support 1 has a lower porosity, and as a result, the porosity of the support increases when one moves across the surface 3 oriented toward the fluid to be processed, from this surface 3 toward the surface 1₁ for extraction of the filtrate. In the examples illustrated in FIGS. 2 and 3, showing a single-channel tubular support and the associated membrane, the porosity of the support increases when one moves across the surface 3 of the channel 2, from the channel 2 toward the external surface 1₁. This variation of transverse porosity is due, for example, to a partial clogging, along the support 1, from the surface 3 oriented toward the fluid to be processed. Nevertheless, the longitudinal porosity, for its part, remains more-or-less constant, when one moves parallel to the surface oriented toward the fluid to be processed, in the direction of flow of the fluid to be processed, that is along the channel, from one of its ends to the other, in the example illustrated in FIG. 2. This clogging is described as “partial”, since the support is not totally clogged as it is still allowing fluid to pass. Over a given constant depth measured from the surface 3 of the support oriented toward the fluid to be processed, the support 1 has an increasing average transverse porosity when one moves toward the interior of the support, across the surface 3 of the support oriented toward the fluid to be processed, and moving away from this surface 3 oriented toward the fluid to be processed. Advantageously, the partial clogging c varies when one moves perpendicularly to the surface 3 oriented toward the fluid to be processed and creates a gradient of average porosity, over a constant depth p, which increases when one moves away from this surface 3. The part of the support 1 that is most clogged with the lowest average porosity is located close to the surface 3 oriented toward the fluid to be processed and therefore toward the channel 2 in the illustrated example, while the part that is least clogged with the highest average porosity is located toward the surface 1₁ for extraction of the filtrate (external peripheral surface 1₁ of the support 1 in the example illustrated in FIG. 2).

According to a preferred variant of the invention, the average diameter of the pores of the support increases within the support 1, when one moves across the surface 3 of the support oriented toward the fluid to be processed, from the surface 3 oriented toward the fluid to be processed toward the surface 1₁ for extraction of the filtrate.

The gradient of average porosity is created by the penetration, in an initial support, from the surface 3 of the support oriented toward the fluid to be processed, of particles whose average diameter is less than the average diameter of the pores of the initial support, this being used to obtain partial clogging c of the support 1. According to the example illustrated in FIG. 2, this partial clogging is created over a certain constant depth p (that is less than or equal to depth e), measured from the surface 3 of the support oriented toward the fluid to be processed. This depth p is determined from the surface 3 of the support oriented toward the fluid to be processed. Clogging c corresponding to the penetration of the particles takes place over a depth p which depends on the size, that is the diameter of the particles, and on the experimental penetration conditions. In general, the depth p of the penetration is large, and is in accordance with the desired permeability reduction. For example, the support 1 is clogged over a depth p greater than the average radius of the agglomerated particles constituting the initial support, and preferably greater than their average diameter, and the maximum depth is that attained by the finest particles, during he clogging process. In an advantageous manner, the partial clogging is created over a depth p that is equal to or greater than 2.5 μm, preferably equal to or greater than 5 μm. The support of the invention has a permeability that is artificially reduced in relation to the initial support, but homogeneous when one moves parallel to the surface oriented toward the fluid to be processed, in the direction of flow of the fluid to be processed.

According to a first variant of the invention, the average transverse porosity can increase more-or-less continuously, when the one moves away from the surface 3 of the support oriented toward the fluid to be processed. According to another variant, the average transverse porosity can increase in steps Pi. The said steps are preferably all of a more-or-less identical length taken across the surface 3 oriented toward the fluid to be processed.

It should be noted that the examples described in FIGS. 2 and 3 concern a single-channel support that includes a channel of cylindrical shape of more-or-less ovoid straight cross section. Of course, the subject of the invention can equally well be implemented on supports that have one or more channels of varied and diverse shapes. In the same sense, it is clear that the subject of the invention can be applied to a support that includes at least one channel 2 of polygonal cross section, arranged in a porous block. In the case of a support 1 of the flat or plane type, it is possible to circulate the fluid to be processed directly on one of the faces 3 of the support, with the filtrate exiting on the other face 1₁, with no channel being arranged in the mass of the support. In this type of porous support 1 of the plane type, a series of channels 2 each with a rectangular straight cross section can also be superimposed. In the case of supports that include several channels, the support has porosity as specified above, over a certain depth extending from each internal area 3 delimiting a channel 2. The support therefore has a modified porosity over the volumes adjacent to the internal area 3, located both between a channel 2 and the external surface 1₁ of the support, and between two channels 2.

The porous support of the invention therefore has a porosity defined by an increasing average transverse porosity when one moves in the mass of the support, in the same direction as the filtrate, and a constant average longitudinal porosity, this being used to obtain a permeability for this support that is lower than the permeability of the conventional supports of previous design.

The subject of the invention also proposes a process to create a filtration support 1 as described above. Such a process includes a stage that consists of modifying the initial support by the penetration, from the surface 3 of the support oriented toward the fluid to be processed, of inorganic particles whose average diameter is less than the average diameter dp of the pores of the initial support before modification. This penetration is effected so as to achieve an increasing average transverse porosity when one moves toward the interior of the support, across the surface 3 of the support oriented toward the fluid to be processed, from this surface 3 toward the surface 1₁ of the support 1 for extraction of the filtrate, the average longitudinal porosity of the support 1, for its part, being homogeneous when one moves toward the interior of the support 1 parallel to the surface of the support oriented toward the fluid to be processed, in the direction of flow of the fluid to be processed.

By average diameter less than the average diameter dp of the pores of the initial support, is preferably meant that the average diameter of the inorganic particles is between dp/100 and dp/2.

The penetration of the particles to the interior of the initial support is achieved by means of a deflocculated suspension of such particles. Deflocculation of the suspension is necessary in order to prevent the formation of lumps of particles and therefore to keep the particles in individual form capable of penetrating into the interior of the pores of the support. Advantageously, the suspension has low viscosity.

Such particles are composed of an inorganic material such as metal oxides, with the inorganic material making up the inorganic particles capable of being identical to that constituting the support and/or any separation layer 5.

The penetration stage is followed by a stage of sintering, which is used to group together the particles present in the pores of the solid support 1, leading to an enlargement and an amalgamation of the said particles, and determining the clogging of the porous support 1. The description that follows concerns a process designed to create a support as illustrated in FIG. 2, which has at least one internal channel 2. In this case, the penetration of particles of the same grain size or of a mixture of particles of different grain size is effected inside the pores of the support over a depth p, measured from the internal area 3 of the support 1 oriented toward the fluid to be processed, that is constant when one moves parallel to the surface 3 of the support 1 oriented toward the fluid to be processed. Such a constant penetration over the length of the support, but variable over the depth (meaning the deeper one goes in relation to the internal area 3 of the channel 2, the less will be the penetration of particles), can be effected by the coating method. This method consists of placing the porous support 1 vertically and filling the channel 2 with a deflocculated suspension of inorganic particles whose average diameter is less than the average diameter dp of the pores of the support (before clogging) by means of a pump of the peristaltic type and with a variable speed of rotation. The fill time of the channel is called Tr. The time during which the support is kept filled with the suspension, by acting on the speed of rotation of the pump, is called Ta. The support is then emptied by reversing the direction of rotation of the pump, with the emptying time being called Tv. The three times Tr, Ta, and Tv determine the contact time Tc between each point of the internal area 3 of the support 1 and the suspension.

At a point, x, of the internal area 3 of the support 1 located at height h, the contact time Tc with the suspension is equal to:

Tc=(Tr+Ta+Tv)−Ss/Qpr*h−Ss/Qpv*h (I)

where:

Tr=fill time

Ta=full-tube wait time

Tv=emptying time

Tc=contact time

Qpr=flow in the pump during filling

Qpv=flow in the pump while emptying

Ss=section of the channels

h=fill height

The depth p of penetration of the particles inside the support depends on the contact time Tc between the porous support 1 and the suspension. Also, by adjusting parameters Tr, Ta, and Tv, it is possible to obtain a depth p of penetration that is more-or-less constant from the top end to the bottom end of the support. By using different values of the contact time Tc, and adjusting Tr, Ta and Tv according to the relation I, it is possible to choose the mass of the inorganic particles penetrating inside the support 1. The variation of penetration depth of the particles occurs naturally in parallel with measurement of the accumulation within the support 1 and by reducing the capillary aspiration of the latter.

Another technique that can be used to achieve homogeneous clogging c along the channel is to effect a vertical penetration in two stages, that is by turning over the support, and therefore by reversing its top and bottom ends, in the middle of the penetration.

In fact, the invention allows one to manufacture customised supports and, as a consequence, membranes with a porosity and therefore with a permeability in accordance with any requirement. In particular, by reducing the permeability of the support, the invention can be used to reduce the permeability of the membrane obtained from such a support. The process also has the advantage of controlling the final permeability of the support, and even of the membrane. In fact, it is possible to modulate the level of permeability by the adjustment of different parameters, such as:

the choice of the size of the particles, which in particular affects the depth of penetration and the clogging density,

concentration of the deflocculated suspension,

the impregnation time,

the number of impregnation operations. In fact, it is possible to do several penetrations in succession by using particles of the same diameter or of different diameters, and in particular in the case of a gradient in steps of Pi.

Of course, the manufacture of a porous support that includes such a porosity determined, as above, by an increasing average transverse porosity and a constant average longitudinal porosity, can be achieved by processes other than those described above. In particular, in the case of a plane support with no channel, penetration will be effected from the surface 3 intended to be oriented toward the fluid to be processed, this surface 3 being positioned horizontally.

According to another aspect of the invention, arrangements can be made to effect, successively or even simultaneously in a continuous process, clogging of the support and deposition of the separation layer on the surface 3 of the support 1 oriented toward the fluid to be processed. For the clogging of the support, it is therefore possible to use inorganic particles that are identical in dimensions and in composition to those used for deposition of the separation layer 5, during the manufacture of a membrane.

The support of the invention can be used alone, for the filtration in particular of corrosive media, given that its low porosity, directly in the vicinity of the surface 3 of the support 1 oriented toward the fluid to be processed, allows a filtration that is already satisfactory. The surface 3 of the support 1 oriented toward the fluid to be processed therefore outlines the flow surface of the fluid.

According to one of its main applications, the support is used in the design of membranes and is associated with a separation layer 5 having a porosity that is lower, or possibly equal to the lowest porosity of the support, that is to that close to the surface 3 of the support 1 oriented toward the fluid to be processed. According to a preferred variant, the separation layer 5 can have a thickness that reduces with the direction of flow f of the fluid to be processed, as described in EP 1 074 291.

The description that follows aims to provide an implementation example of a membrane according to the invention.

A multi-channel support with an outside diameter of 25 mm and a length of 1200 mm is used. This porous support has an average equivalent pore diameter of 5 μm.

A suspension of particles of zirconium oxide with a grain size of 0.6 μm is prepared. This aqueous suspension is deflocculated by adjustment of the pH using acetic acid, followed by a stage of grinding or lump dispersion in a container containing balls of vitrified zirconium. The suspension contains no organic binder and the concentration of particles is less than 100 g/l. The values of these two parameters are intended to be obtained at very low viscosity.

The support is modified by a coating process, using this suspension. Two deposits are effects, followed by drying. One or more filtration layers are then created. The final membrane obtained has a cut-off threshold of 0.14 μm.

The permeability to water is measured at 500 l/h/m²/bar. As a comparison, the permeability of a membrane manufactured in the same way, but without the stage for modification of the support, is measured at 1500 l/h/m²/bar.

FIG. 4 below shows the permeability of these two membranes during the filtration of milk, and perfectly illustrates the value of the invention. It can be seen clearly that the use of a support of the invention enables the loss of permeability of the membrane to be limited with the operating time.

1. A porous support (1) for the tangential filtration of a fluid to be processed, which has at least one surface (3) oriented toward the fluid to be processed, flowing in a given direction of flow, and a surface (1₁) for extraction of a fraction called the filtrate, flowing through the porous support, this support being obtained by partial clogging of an initial support, characterised in that is has a reduced permeability in relation to the initial support, and which is homogeneous when one moves parallel to the surface (3) of the support oriented toward the fluid to be processed, in the direction of flow of the fluid to be processed.

2. A porous support (1) according to claim 1, characterised in that its permeability is reduced by a factor of between 1.5 and 10 in relation to the initial support.

3. A porous support (1) for the tangential filtration of a fluid to be processed, which has at least one surface (3) oriented toward the fluid to be processed, flowing in a given direction of flow, and a surface (1₁) for extraction of a fraction called the filtrate, flowing through the porous support, characterised in that, over a given constant depth (e) measured from the surface (3) of the support oriented toward the fluid to be processed, the support (1) has an increasing average transverse porosity when one moves toward the interior of the support, across the surface (3) of the support oriented toward the fluid to be processed, from the surface (3) of the support oriented toward the fluid to be processed toward the surface for extraction (1₁) of the filtrate, with the average longitudinal porosity of the support (1), for its part, being homogeneous when one moves toward the interior of the support (1), parallel to the surface (3) of the support oriented toward the fluid to be processed, in the direction of flow of the fluid to be processed.

4. A support (1) according to claim 3, characterised in that the average diameter of the pores increases over the depth (e) of the support (1), when one moves toward the interior of the support (1), across the surface (3) of the support oriented toward the fluid to be processed, from the surface (3) of the support oriented toward the fluid to be processed toward the surface for extraction (1₁) of the filtrate.

5. A support according claim 1, characterised in that the support (1) is obtained by partial clogging (c) of an initial support (1) created from the surface (3) of the support oriented toward the fluid to be processed, over a given constant depth (p) measured from the surface (3) of the support oriented toward the fluid to be processed.

6. A support according to claim 1, characterised in that partial clogging (c) is effected so as to achieve over this constant depth (p) an increasing average transverse porosity when one moves toward the interior of the support across the surface (3) of the support oriented toward the fluid to be processed from the surface (3) of the support oriented toward the fluid to be processed toward the surface for extraction (1₁) of the filtrate.

7. A support according to claim 5, characterised in that the clogging depth (p) is greater than the average radius of the agglomerated particles constituting the initial support, and preferably greater than their average diameter.

8. A support according to claim 5, characterised in that the clogging depth (p) is equal to or greater than 2.5 pm, and preferably equal to or greater than 5 μm.

9. A support according to claim 5, characterised in that the partial clogging (c) of the support is achieved by penetration, from the surface (3) of the support oriented toward the fluid to be processed, of inorganic particles whose average diameter is less than the average diameter (dp) of the pores of the support before clogging, and preferably of between dp/100 and dp/2.

10. A support according to claim 9, characterised in that the penetration of inorganic particles is followed by a sintered process.

11. A support according to claim 5, characterised in that the average transverse porosity increases regularly and continuously over the depth (p) when one moves toward the interior of the support (1) across the surface (3) of the support oriented toward the fluid to be processed, from the surface (3) of the support oriented toward the fluid to be processed toward the surface for extraction (1₁) of the filtrate.

12. A support according to claim 3, characterised in that the average transverse porosity increases in steps (Pi) when one moves toward the interior of the support (1) across the surface (3) of the support oriented toward the fluid to be processed, from the surface (3) of the support oriented toward the fluid to be processed toward the surface for extraction (1₁) of the filtrate.

13. A porous support (1) according to claim 1, characterised in that it includes at least one internal channel (2) open at both of its ends and delimited by the surface (3) of the support oriented toward the fluid to be processed.

14. A membrane (4) for the tangential filtration of a fluid to be processed, associating a porous support (1) according to claim 1 with at least one separation layer (5) for the fluid to be processed, covering the surface (3) of the support oriented toward the fluid to be processed, with the said separation layer (5) having a porosity that is less than that of the support (1).

15. A membrane according to claim 14, characterised in that the separation layer (5) has a thickness which reduces along the direction of flow (f) of the fluid to be processed.

16. A process for the manufacture of a porous support (1) intended for the creation of a membrane (4) for the tangential filtration of a fluid to be processed, which has at least one surface (3) oriented toward the fluid to be processed flowing in a given direction of flow, and a surface (1₁) for extraction of a fraction called the filtrate, flowing through the porous support, characterised in that it includes a stage that consists of modifying a porous initial support by penetration, over a depth (p) that is more-or-less constant, from the surface (3) of the support oriented toward the fluid to be processed, of inorganic particles whose average diameter is less than the average diameter (dp) of the pores of the initial support, so as to achieve an increasing average transverse porosity when one moves toward the interior of the support, across the surface (3) of the support oriented toward the fluid to be processed, from the surface (3) of the support oriented toward the fluid to be processed toward the surface for extraction (1₁) of the filtrate, with the average longitudinal porosity of the support (1), for its part, being homogeneous when one moves toward the interior of the support (1), parallel to the surface (3) of the support oriented toward the fluid to be processed, in the direction of flow of the fluid to be processed.

17. A process according to claim 16, characterised in that the stage that consists of modifying the porous support by penetration is followed by a stage of sintering.

18. A process according to claim 16, characterised in that the average diameter of the inorganic particles is between dp/100 and dp/2.

19. A process according to claim 16, characterised in that the penetration of inorganic particles is effected over a depth (p) that is greater than the average radius of the agglomerated particles constituting the initial support, and preferably greater than their average diameter.

20. A process according to claim 16, characterised in that the clogging of the support decreases over the depth (p) of penetration of the inorganic particles, when one moves toward the interior of the support, across the surface (3) of the support oriented toward the fluid to be processed, from the surface (3) of the support oriented toward the fluid to be processed toward the surface for extraction (1₁) of the filtrate.
